(19) United States
(12) Patent Application Publication
(10) Pub. No.: US 2025/0292765 A1
(43) Pub. Date: Sep. 18, 2025

(54) DEVICE FOR RECOGNIZING MULTI-CHANNEL INPUT VOICE INDEPENDENT ON MICROPHONE ARRAY FORM AND LEARNING METHOD THEREOF

(71) Applicant: ELECTRONICS AND TELECOMMUNICATIONS RESEARCH INSTITUTE, Daejeon (KR)

(72) Inventors: Inkyu AN, Daejeon (KR); HwaJeon Song, Daejeon (KR); Byung Ok Kang, Daejeon (KR); Yoonhyung Kim, Daejeon (KR)

(21) Appl. No.: 19/059,802

(22) Filed: Feb. 21, 2025

(30) Foreign Application Priority Data
Mar. 13, 2024 (KR) 10-2024-0035056

(51) Int. Cl. G10L 15/06; G10L 21/0216; G10L 21/0224; G10L 21/0232; G10L 25/30

(52) U.S. Cl. CPC G10L 15/063; G10L 21/0224; G10L 21/0232; G10L 25/30; G10L 2021/02166

(57) ABSTRACT

A device for recognizing a multi-channel input voice includes a time-frequency transformer that receives channel audio signals extracted from voice data recorded through microphones having unspecified microphone array forms and transforms the channel audio signals into time-frequency domain signals, a speaker and noise mask estimator that receives the time-frequency domain signals and estimates a time-frequency domain mask for voices and noise for speakers, a beamformer estimator that estimates a time-frequency domain signal for voice signals of the speakers from which the noise has been removed from the time-frequency domain signals by using the time-frequency domain mask, a time-frequency inverse transformer that inversely transforms the time-frequency domain signal from which the noise has been removed into a time domain signal, and a learning machine that trains the speaker and noise mask estimator based on a loss function obtained by comparing the inversely-transformed time domain signal and a pre-defined answer signal.

### CROSS REFERENCE TO RELATED APPLICATION

This application claims priority from and the benefit of Korean Patent Application No. 10-2024-0035056, filed on Mar. 13, 2024, which is hereby incorporated by reference for all purposes as if set forth herein.

### BACKGROUND

### 1. Technical Field

The present disclosure relates to a device for recognizing a multi-channel input voice independent on a microphone array form and a learning method thereof.

### 2. Description of Related Art

With the recent advancement of a deep learning technology, a voice recognition technology has achieved better performance improvements, and is applied and serviced for various fields. However, in complex real-world complicated environments where multiple sounds occur simultaneously, recognition performance often degrades. In particular, in a situation where multiple speakers are speaking at the same time, such as in a multi-speaker environment, there is a significant drop in recognition performance, as the system struggles to accurately distinguish the speech of each speaker.

In order to overcome such a limit, deep learning-based multi-channel input voice recognition schemes using a microphone array including multiple microphones has recently been proposed. Such a scheme is a technology in which space information of an actual environment can be considered and used by simultaneously using sounds recorded through microphones. That is, this scheme enables only a voice signal desired by a user to be extracted and recognized by considering a location where a sound is generated. Accordingly, it is possible to extract and recognize a desired voice signal even in an environment surrounding noise is present.

However, the existing multi-channel input voice recognition technology has a problem in that it depends on a specific microphone array form. For example, assuming that data that are used in the training of a multi-channel input voice recognition model are a 4-channel linear microphone array, other data not recorded through a 4-channel linear microphone array cannot be used in the training process. Furthermore, there is a problem in that the existing multi-channel input voice recognition technology does not exhibit sufficient performance when a different microphone array form is used after the training.

Several devices (e.g., smartphones, tablet PCs, and smart speakers) that are used in real life require an additional task in order to use each device having a multi-channel input voice recognition device mounted thereon because the several devices have different microphone array forms depending on different locations or numbers of microphones. That is, it is necessary to secure a sufficient amount of new data by using a microphone having a desired microphone array form. Accordingly, there is a need for a process of training the multi-channel input voice recognition device again.

Recently, multi-channel input voice recognition schemes which may operate in various forms of microphone arrays have recently been proposed, but have restrictions in that a microphone form or the number of microphones needs to remain consistent. For example, the microphone array needs to follow a circular shape, and the number of microphones needs to be fixed.

Accordingly, there is a need for a technology capable of stable multi-channel input voice recognition even without being restricted by a microphone array form.

### PRIOR ART DOCUMENT

### Patent Document

Korean Patent Application Publication No. 10-2021-0089347 (Jul. 16, 2021)

### SUMMARY

Various embodiments are directed to providing a device for recognizing a multi-channel input voice independent on a microphone array form, which stably operates in various microphone array forms and can stably perform voice recognition even in a desired microphone array form by using a small amount of learning data, and a learning method of the device.

However, objects of the present disclosure to be achieved are not limited to the aforementioned object, and other objects may be present.

A device for recognizing a multi-channel input voice independent on a microphone array form according to a first aspect of the present disclosure includes a time-frequency transformer configured to receive a plurality of channel audio signals extracted from voice data recorded through a plurality of microphones having unspecified microphone array forms and to transform the plurality of channel audio signals into a plurality of time-frequency domain signals, a speaker and noise mask estimator configured to receive the plurality of time-frequency domain signals and to estimate a time-frequency domain mask for voices and noise for a plurality of speakers, a beamformer estimator configured to estimate a time-frequency domain signal for voice signals of the plurality of speakers from which the noise has been removed from the plurality of time-frequency domain signals by using the time-frequency domain mask, a time-frequency inverse transformer configured to inversely transform the time-frequency domain signal from which the noise has been removed into a time domain signal, and a learning machine configured to train the speaker and noise mask estimator based on a loss function obtained based on results of a comparison between the inversely-transformed time domain signal and a pre-defined answer signal.

Furthermore, a method performed by a device for recognizing a multi-channel input voice independent on a microphone array form according to a second aspect of the present disclosure includes extracting a plurality of channel audio signals from voice data recorded through a plurality of microphones having unspecified microphone array forms and transforming the plurality of channel audio signals into a plurality of time-frequency domain signals, estimating a time-frequency domain mask for voices and noise for a plurality of speakers by inputting the plurality of time-frequency domain signals to a speaker and noise mask estimator, estimating time-frequency domain signals for voice signals of the plurality of speakers from which the noise has been removed from the plurality of time-frequency domain signals by using the time-frequency domain mask, inversely transforming the time-frequency domain signal from which the noise has been removed into a time domain signal, and training the speaker and noise mask estimator based on a loss function obtained by comparing the inversely-transformed time domain signal and a pre-defined answer signal.

A computer program according to another aspect of the present disclosure executes a learning method for multi-channel input voice recognition and is stored in a computer-readable recording medium.

Other details of the present disclosure are included in the detailed description and the drawings.

According to the embodiments of the present disclosure, a stable operation is possible even in various environments because inputs from various forms of microphone arrays are possible unlike in the existing multi-channel input voice recognition technology in which learning and an operation are performed in dependence on a specific microphone array form.

Furthermore, it is possible to stably perform voice recognition even in a microphone array form desired by a user because the learning of a model is performed through a meta-learning method. Accordingly, it is possible to reduce the amount of data necessary for learning and to provide a voice recognition device which can be rapidly applied even in a new environment.

Furthermore, after meta-learning, fine tuning can be performed using a small amount of training data, thus allowing for more stable speech recognition performance with the desired microphone array type.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a block diagram of a device for recognizing a multi-channel input voice according to an embodiment of the present disclosure.

FIG. 2 is a diagram for describing a process of deriving an optimal model parameter for an initial model in an embodiment of the present disclosure.

FIG. 3 is a diagram for describing a fine-tuning learning process according to an embodiment of the present disclosure.

FIG. 4 is a diagram for describing a loss function for fine tuning in an embodiment of the present disclosure.

FIG. 5 is a diagram for describing a beamformer estimator according to an embodiment of the present disclosure.

FIG. 6 is a diagram for describing an embodiment in which the device for recognizing a multi-channel input voice on which learning has been completed has been applied in an embodiment of the present disclosure.

FIG. 7 is a block diagram of the device for recognizing a multi-channel input voice according to an embodiment of the present disclosure.

FIG. 8 is a flowchart of a learning method for multi-channel input voice recognition according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

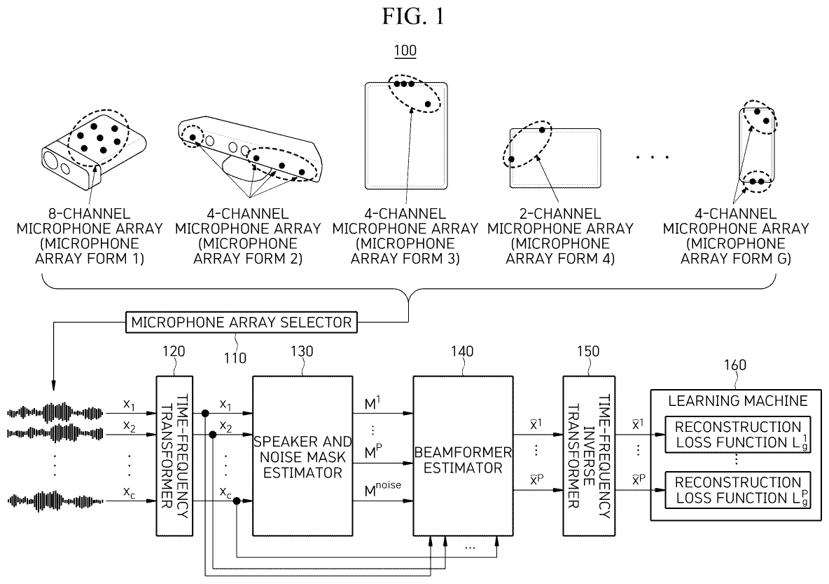

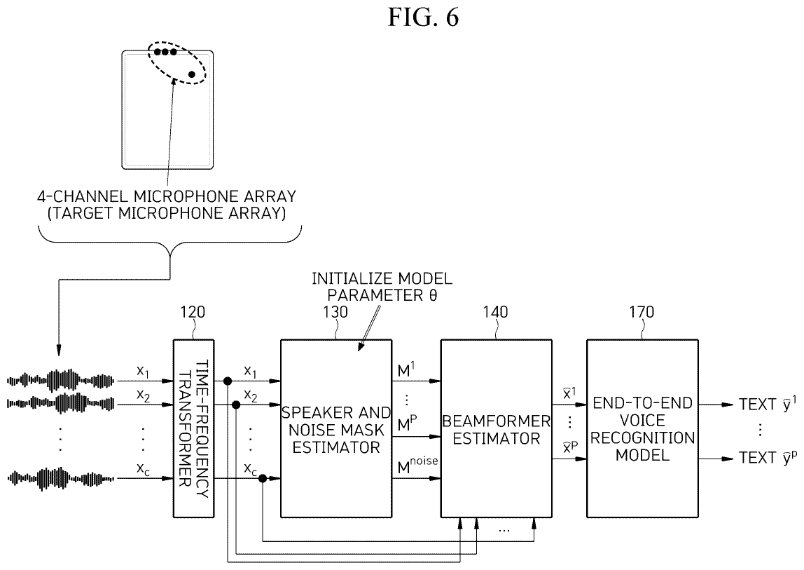

Hereinafter, a device 100 for recognizing a multi-channel input voice according to an embodiment of the present disclosure is described with reference to FIGS. 1 to 6. In this case, a learning process of the device 100 for recognizing a multi-channel input voice is described with reference to FIGS. 1 to 5. A process of performing voice recognition by using the device 100 for recognizing a multi-channel input voice is described with reference to FIG. 6.

FIG. 1 is a block diagram of the device 100 for recognizing a multi-channel input voice according to an embodiment of the present disclosure.

The device 100 for recognizing a multi-channel input voice according to an embodiment of the present disclosure includes a microphone array selector 110, a time-frequency transformer 120, a speaker and noise mask estimator 130, a beamformer estimator 140, a time-frequency inverse transformer 150, and a learning machine 160.

The device 100 for recognizing a multi-channel input voice according to an embodiment of the present disclosure estimates an initial model parameter that is not restricted by a microphone array form based on meta-learning. The initial model parameter that is learnt as described above may stably operate in various forms of microphone arrays. Accordingly, voice recognition can be performed through fine-tuning using a small amount of data recorded through a microphone array to be subsequently used.

The microphone array selector 110 selects and receives voice data recorded through a microphone having any one microphone array form, among voice data recorded through microphones having a plurality of microphone array forms, which are mounted on various types of devices. For example, each of the various types of devices may be a device on which a plurality of microphones having array forms, such as an RGB-D camera, a tablet PC, and a smart phone, is mounted, and is not limited to a special type or form of a microphone.

G heterogeneous devices are illustrated in FIG. 1. The microphone array selector 110 selects device having a g-th microphone array form and receives voice data. If the selected g-th microphone array form includes C microphones, the microphone array selector 110 extracts audio signals {x₁, . . . , x_{C}} of a C channel and transmits the audio signals to the time-frequency transformer 120. In this case, the number of channels may be different in each of the microphone array forms.

The time-frequency transformer 120 is a short-time Fourier transform (STFT) transformer, and it receives a plurality of channel audio signals {x₁, . . . , x_{C}} and transforms the plurality of channel audio signals into a plurality of time-frequency domain signals {X₁, . . . , X_{C}}. In this case, each of the time-frequency domain signals includes pieces of T time bin information and pieces of F frequency bin information.

The speaker and noise mask estimator 130 receives the plurality of time-frequency domain signals {X₁, . . . , X_{C}} and estimates a time-frequency domain mask for voices and noise for a plurality of speakers. That is, the speaker and noise mask estimator 130 estimates the time-frequency domain mask M^{noise} for time-frequency domain masks {M¹, . . . , M^{P}} for voices and noise for P speakers. In this case, the mask is a filter that is designed to have a value of 0 and 1, that is, a binary form, and is used to determine whether to extract only a voice signal or noise of a target speaker in a specific time and frequency domain.

In an embodiment of the present disclosure, the speaker and noise mask estimator 130 may be an array-agnostic estimator. Furthermore, in an embodiment of the present disclosure, the speaker and noise mask estimator 130 may operate regardless of a microphone array form and the number of channels for an input signal. That is, the speaker and noise mask estimator 130 exhibits consistent performance even in various microphone array forms, and provides flexibility by which an operation is not restricted depending on the locations or number of microphones.

The beamformer estimator 140 estimates time-frequency domain signals for the voice signals of a plurality of speakers from which noise has been removed from a plurality of time-frequency domain signals by using the time-frequency domain masks. That is, the beamformer estimator 140 estimates time-frequency domain signals {\hat{X}₁, . . . , \hat{X}^{P}} for the clean voice signals of the P speakers from the time-frequency domain signals {X₁, . . . , X_{C}} of the C channel by using the time-frequency domain masks {M¹, . . . , M^{P}}, M^{noise} for the P speakers and noise.

In an embodiment of the present disclosure, the beamformer estimator 140 may be a Wiener filter-based minimum variance distortionless response (MVDR) beamformer estimator 140.

The time-frequency inverse transformer 150 is an inverse short-time Fourier transform (ISTFT) transformer, and it receives the time-frequency domain signals {\hat{X}¹, . . . , \hat{X}^{P}} from which noise has been removed and inversely transforms the time-frequency domain signals into time domain signals {\hat{x}¹, . . . , \hat{x}^{P}}.

The learning machine 160 trains the speaker and noise mask estimator 130 based on a loss function that is defined through the results of a comparison between the time domain signals {\hat{x}¹, . . . , \hat{x}^{P}} of the P speakers, which have been inversely transformed, and pre-defined answer signals {\hat{x}¹, . . . , \hat{x}^{P}}. In an embodiment of the present disclosure, the time-frequency transformer 120, the beamformer estimator 140, and the time-frequency inverse transformer 150 each include elements that do not need to be trained because each of the time-frequency transformer 120, the beamformer estimator 140, and the time-frequency inverse transformer 150 performs a matrix operation using an input signal. In contrast, the speaker and noise mask estimator 130 needs to be trained because the speaker and noise mask estimator includes a model h_{θ} consisting of a learnable parameter θ.

Specifically, the learning machine 160 may obtain the entire loss function by calculating the sum of reconstruction loss functions that are each defined as a distance between the inversely-transformed time domain signals and an answer signal for each speaker, and may perform learning by tuning a model parameter that constitutes the speaker and noise mask estimator 130 based on the entire loss function.

$${ℒ}_{g} ( {h}_{θ} ) = {\sum }_{p} {ℒ}_{g}^{p} ( {h}_{θ} ) = {\sum }_{p} d ( {\hat{x}}^{p} , {x}^{p} ) \qquad ( 1 )$$

In Equation 1, the entire loss function [symbol] _{g}(h_{θ}) indicates a reconstruction loss function of a g-th microphone array form, which is calculated by the model h_{θ}. The entire loss function [symbol] _{g}(h_{θ}) is calculated as the sum of reconstruction loss functions [symbol] _{g}^{p}(h_{θ}) for the P speakers.

Furthermore, the reconstruction loss function [symbol] _{g}^{p}(h_{θ}) indicates a reconstruction loss function of a p-th speaker, which is calculated by the model h_{θ}. The reconstruction loss function [symbol] _{g}^{p}(h_{θ}) of each speaker is calculated by using a function d(·, ·) that measures a distance between a time domain signal \hat{x}^{p} and an answer signal x^{p} for the estimated speaker. That is, the function d(·, ·) is a function that measures a distance between the two features, that is, the time domain signal \hat{x}^{p} and the answer signal x^{p}. For example, L1, L2, Cosine, or Euclidean Distance may be used as the function d(·, ·).

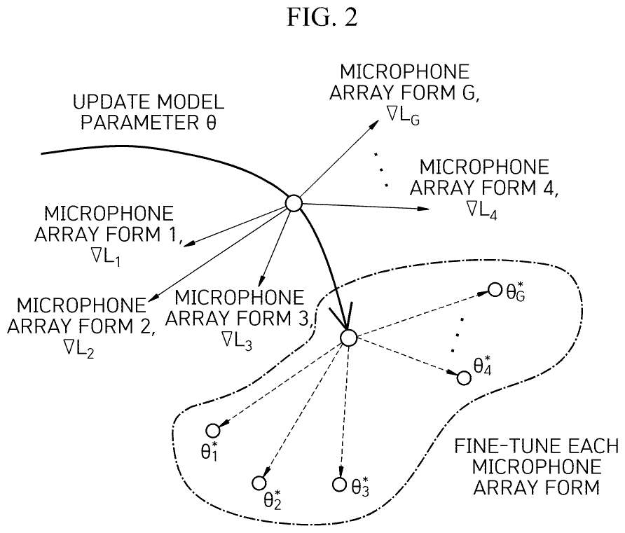

FIG. 2 is a diagram for describing a process of deriving an optimal model parameter for an initial model in an embodiment of the present disclosure.

In an embodiment, the learning machine 160 may calculate all of G loss functions { [symbol] ₁(h_{θ}), . . . , [symbol] _{G}(h_{θ})} corresponding to various types of devices having different microphone array forms according to Equation 1, and may then calculate temporary model parameters {θ₁′, . . . , θ_{G}′} for G microphone array forms corresponding to the various types of devices according to Equation 2 by using a gradient decent algorithm.

$${θ}_{g}^{′} = θ - α {∇}_{θ} {ℒ}_{g} ( {h}_{θ} ) \qquad ( 2 )$$

In Equation 2, θ_{g}′ indicates the temporary model parameter of the g-th microphone array form, and α indicates a learning rate. According to Equation 2, the temporary model parameter θ_{g}′ is calculated by subtracting a value, which is obtained by multiplying the slope of the loss function in a current model parameter θ by the learning rate, from the current learnable parameter θ.

The learning machine 160 may update the model parameter of the speaker and noise mask estimator 130 with an optimal model parameter θ derived by performing learning in a way to minimize the loss function by applying the temporary model parameters {θ₁′, . . . , θ_{G}′} calculated according to Equation 2 to the speaker and noise mask estimator 130, then calculating the entire loss function according to Equation 1 again, and applying the gradient decent algorithm again. Such a process is expressed in Equation 3.

$$θ ← θ - β {∇}_{θ} {\sum }_{g} {ℒ}_{g} ( {h}_{{θ}_{g}^{′}} ) \qquad ( 3 )$$

In Equation 3, β indicates the learning rate. The optimal model parameter θ may be obtained by repeatedly performing Equations 2 and 3. In a subsequent process, the model h_{θ} is used in a specific microphone array form to be used through fine-tuning by using a small amount of data.

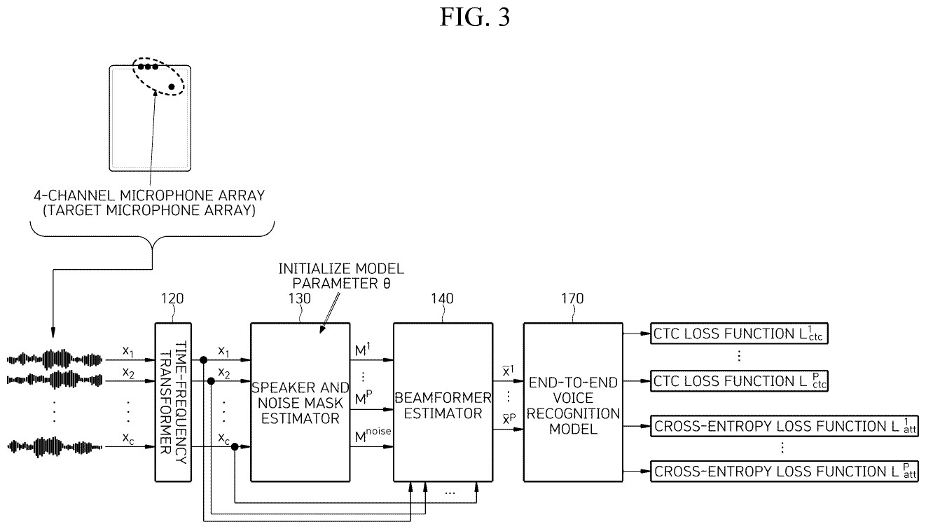

FIG. 3 is a diagram for describing a fine-tuning learning process according to an embodiment of the present disclosure.

If an optimal initial model parameter is estimated and applied as described above, the device 100 for recognizing a multi-channel input voice can stably operate in various microphone array forms. In addition, in an embodiment of the present disclosure, a fine-tuning process is performed by using a small amount of data in order for the device 100 to operate in a microphone array form to be used.

In general, there are many cases in which learning data recorded through a microphone array having a specific form desired by a user are not present. A lot of time and costs are consumed to generate a sufficient amount of learning data. Accordingly, in an embodiment of the present disclosure, effective performance can be achieved even with a small amount of data by performing fine-tuning by using the optimal model parameter θ.

To this end, in an embodiment of the present disclosure, C channel time domain signals {x₁, . . . , x_{C}} are extracted from a specific microphone array form (e.g., a 4-channel microphone array mounted on a tablet PC) to be used. Next, the time-frequency domain signals {\hat{X}¹, . . . , \hat{X}^{P}} of P speakers from which noise has been removed are obtained by passing the C channel time domain signals {x₁, . . . , x_{C}}, that is, an input, through the time-frequency transformer 120, the speaker and noise mask estimator 130, and the beamformer estimator 140. This process is the same as that described with reference to FIG. 1. The speaker and noise mask estimator 130 is initialized by the optimal model parameter θ through the process described with reference to FIG. 2 and Equations 2 and 3.

The end-to-end voice recognition model 170 receives the time-frequency domain signals {\hat{X}¹, . . . , \hat{X}^{P}} of the P speakers from which noise has been removed, and performs voice recognition on the time-frequency domain signals. In this case, in an embodiment of the present disclosure, for the fine learning of the end-to-end voice recognition model 170, a loss function for fine-tuning may be defined as in Equation 4 by comparing the results of the voice recognition and pre-pared answer information.

$${ℒ}_{asr} = {\sum }_{p} {ℒ}_{ctc}^{p} + {ℒ}_{att}^{p} \qquad ( 4 )$$

In an embodiment, the loss function for fine-tuning is constructed by adding a connectionist temporal classification (CTC) loss function and a cross-entropy loss function for each speaker. In Equation 4, [symbol] _{ctc}^{p} indicates the CTC loss function of the p-th speaker, and [symbol] ₐₜₜ^{p} indicates the cross-entropy loss function of the p-th speaker.

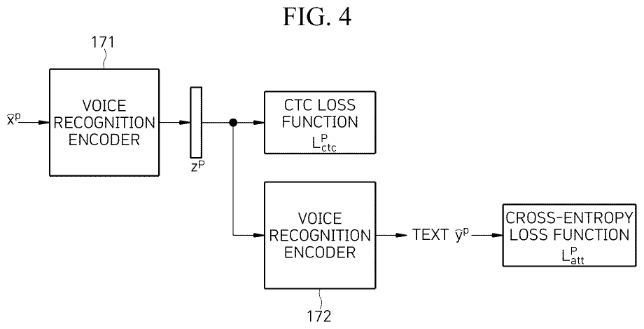

FIG. 4 is a diagram for describing a loss function for fine tuning in an embodiment of the present disclosure.

In an embodiment, the end-to-end voice recognition model 170 may include a voice recognition encoder 171 and a voice recognition decoder 172. The voice recognition encoder 171 receives the time-frequency domain signal of a specific speaker from which noise has been removed, and embeds the time-frequency domain signal as a vector that constitutes a hidden vector space. The voice recognition decoder 172 receives the vector that constitutes the hidden vector space and outputs the results of voice recognition of the specific speaker.

Specifically, assuming that p∈{1, . . . , P}, the estimated clean voice \hat{X}^{p} (i.e., a time-frequency domain signal from which noise has been removed) of the p-th speaker is embedded as a vector z^{p} that constitutes a hidden vector space by inputting the estimated clean voice \hat{X}^{p} to the voice recognition encoder 171. Next, the voice recognition result text ŷ^{p} of the p-th speaker is output by inputting the vector z^{p} of the hidden vector space to the voice recognition decoder 172.

In this case, the CTC loss function [symbol] _{ctc}^{p} is defined by using the CTC scheme from the vector z^{p} of the hidden vector space for each speaker. The cross-entropy loss function [symbol] ₐₜₜ^{p} is defined by measuring cross-entropy between the voice recognition result text ŷ^{p} and answer text.

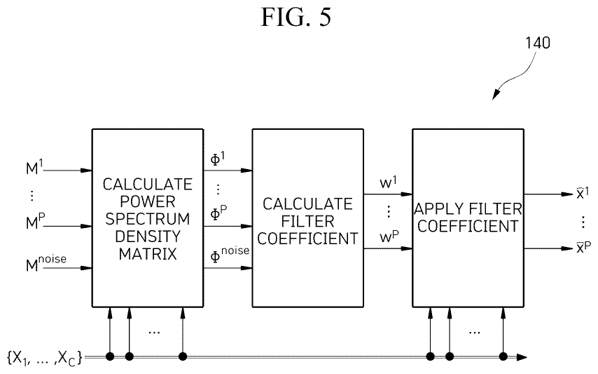

FIG. 5 is a diagram for describing the beamformer estimator 140 according to an embodiment of the present disclosure.

In an embodiment, the beamformer estimator 140 receives the time-frequency domain masks {M¹, . . . , M^{P}}, M^{noise} of the P speakers and the plurality of time-frequency domain signals {X¹, . . . , X_{C}} of the C channel. The beamformer estimator 140 may calculate a power spectrum density (PSD) matrix for voices and noise for the plurality of P speakers according to Equation 5 based on the time-frequency domain masks {M¹, . . . , M^{P}}, M^{noise} and the plurality of time-frequency domain signals {X₁, . . . , X_{C}}, that is, an input.

$${Φ}^{p} ( f ) = \frac{1}{{\sum }_{t = 1}^{T} {M}^{p} ( t , f )} {\sum }_{t = 1}^{T} {M}^{p} ( t , f ) \vec{X} ( t , f ) {\vec{X} ( t , f )}^{H} \qquad ( 5 )$$

In Equation 5, assuming that p∈{1, . . . , P, noise}, ∠^{p}(f) indicates a PSD matrix for the p-th speaker or noise. Furthermore, M^{p}(t, f) indicates the mask coefficient of a t-th time bin and f-th frequency bin for the p-th speaker or noise. \vec{X}(t, f) indicates a column vector including the time-frequency signals of the t-th time bin and the f-th frequency bin (i.e., \vec{X}(t, f)=[X₁(t, f), . . . , X_{C}(t, f)]^{T}) for all of the C channels.

Furthermore, the filter coefficient of the beamformer estimator 140 may be calculated according to Equation 6 based on the PSD matrix {Φ¹(f), . . . , Φ^{P}(f), Φ^{noise}(f)} of the P speakers and noise.

$${w}^{p} ( f ) = \frac{{( {\sum }_{p \neq j} {Φ}^{j} ( f ) )}^{- 1} {Φ}^{p} ( f )}{tr ( {( {\sum }_{p \neq j} Φ j ( f ) )}^{- 1} Φ p ( f ) )} \vec{u} \qquad ( 6 )$$

In Equation 6, assuming that p∈{1, . . . , P}, w^{p}(f) indicates the filter coefficient of a p-th sound source. tr(·) is a diagonal sum trace, and is used to calculate the sum of the diagonal elements of a matrix. \vec{u} is one-hot vector indicative of a reference microphone.

Furthermore, the beamformer estimator 140 may estimate a time-frequency domain signal for the voice signals of a plurality of speakers from which noise has been removed by applying the filter coefficient to time bin information and frequency bin information in a time-frequency domain signal for a voice and noise for a speaker. That is, the filter coefficient w^{p}(f) calculated according to Equation 6 is used to extract the clean voices of the P speakers in Equation 7.

$${\hat{X}}^{p} ( t , f ) = {{w}^{p} ( f )}^{H} \vec{X} ( t , f ) \qquad ( 7 )$$

In Equation 7, assuming that p∈{1, . . . , P}, \hat{X}^{p}(t, f) indicates a signal obtained by extracting only the clean voice of the speaker p, which has been extracted by the beamformer estimator 140. Furthermore, w^{p}(f) is the filter coefficient calculated according to Equation 6. \vec{X}(t, f) indicates a column vector including the time-frequency signals of the t-th time bin and the f-th frequency bin for all of the C channels (Equation 5).

FIG. 6 is a diagram for describing an embodiment in which the device 100 for recognizing a multi-channel input voice on which learning has been completed has been applied in an embodiment of the present disclosure.

After an optimization process for a model parameter and fine-tuning learning are completed, voice recognition may be performed by using a microphone array (e.g., a 5-channel linear microphone array) to be used.

That is, when the time domain signals {x₁, . . . , x_{C}} of the C channel are received from a specific microphone array to be used, the voice recognition result text {ŷ¹, . . . , ŷ^{P}} for the P speakers is output by using the time-frequency transformer 120, the speaker and noise mask estimator 130, the beamformer estimator 140, and the end-to-end voice recognition model 170.

A process of applying the voice recognition device 100 is the same as the method performed in the fine-tuning learning, which has been described with reference to FIGS. 3 and 4. In this case, the speaker and noise mask estimator 130 and the end-to-end voice recognition model 170 are applied after being initialized by the model parameter obtained in the fine-tuning learning process.

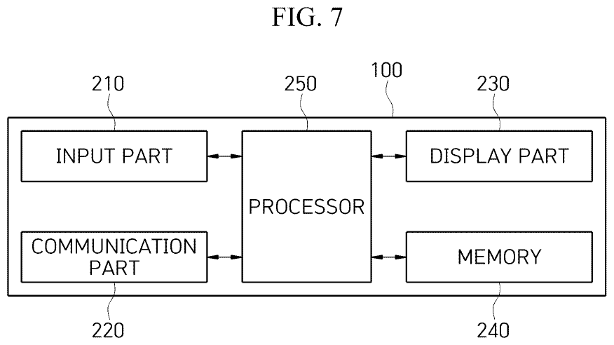

FIG. 7 is a block diagram of the device 100 for recognizing a multi-channel input voice according to an embodiment of the present disclosure.

The device 100 for recognizing a multi-channel input voice according to an embodiment of the present disclosure includes an input unit 210, a communication unit 220, a display unit 230, memory 240, and a processor 250.

The input unit 210 generates input data in accordance with a user input. The user input may include a user input relating to data to be processed by the device 100 for recognizing a multi-channel input voice. The input unit 210 may include at least one input means. The input unit 210 may include a key board, a key pad, a dome switch, a touch panel, a touch key, a mouse, and a menu button. The input unit 210 may be constructed to be integrated with any one of the various types of devices. In this case, the input unit 210 may include a specific microphone array.

The communication unit 220 transmits and receives data between the internal components or performs communication with an external device, such as an external server. The communication unit 220 may include both a wired communication module and a wireless communication module. The wired communication module may be implemented by using a power line communication device, a telephone line communication device, cable home (MoCA), Ethernet, IEEE1294, an integrated wired home network, or an RS-485 controller. Furthermore, the wireless communication module may be constructed in the form of a module for implementing a function, such as a wireless LAN (WLAN), Bluetooth, a HDR WPAN, UWB, ZigBee, Impulse Radio, 60 GHz WPAN, Binary-CDMA, a wireless USB technology, a wireless HDMI technology, 5^{th} generation (5G) communication, long term evolution-advanced (LTE-A), long term evolution (LTE), or wireless fidelity (Wi-Fi).

The display unit 230 displays display data according to an operation of the device 100 for recognizing a multi-channel input voice. The display unit 230 may display the output of an input voice itself or the results of voice recognition transformed into a character string. The display unit 230 includes a liquid crystal display (LCD), a light emitting diode (LED) display, an organic LED (OLED) display, a micro electro mechanical systems (MEMS) display, and an electronic paper display. The display unit 230 may be implemented as a touch screen by being coupled with the input unit 210.

The memory 240 stores programs for applying the training of a model and a trained model in the device 100 for recognizing a multi-channel input voice. In this case, the memory 240 collectively refers to nonvolatile storage that continue to retain information stored therein although power is not supplied thereto and volatile storage. For example, the memory 240 may include NAND flash memory, such as a compact flash (CF) card, a secure digital (SD) card, a memory stick, a solid-state drive (SSD), and a micro SD card, magnetic computer storage, such as a hard disk drive (HDD), and optical disc drives, such as CD-ROM and DVD-ROM.

The processor 250 may control at least another component (e.g., a hardware or software component) of the device 100 for recognizing a multi-channel input voice by executing software, such as a program, and may perform various types of data processing or operations.

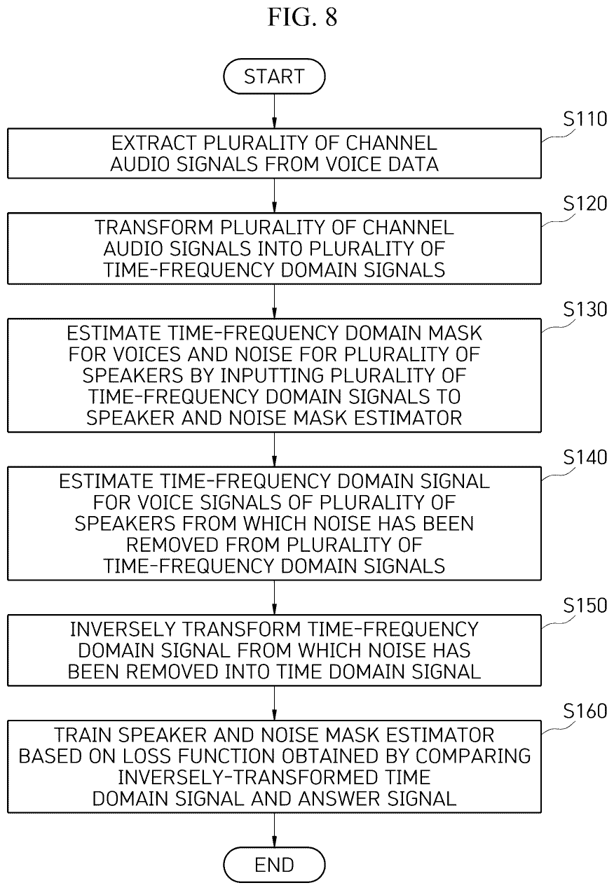

Hereinafter, a learning method for multi-channel input voice recognition, which is performed by the device 100 for recognizing a multi-channel input voice, is described with reference to FIG. 8.

FIG. 8 is a flowchart of a learning method for multi-channel input voice recognition according to an embodiment of the present disclosure.

First, a plurality of channel audio signals is extracted from voice data recorded through a plurality of microphones having unspecified microphone array forms and is transformed into a plurality of time-frequency domain signals (S110).

Next, a time-frequency domain mask for voices and noise for a plurality of speakers are estimated by inputting the plurality of time-frequency domain signals to the speaker and noise mask estimator 130 (S120).

Next, a time-frequency domain signal for the voice signals of the plurality of speakers from which noise has been removed are estimated from the plurality of time-frequency domain signals by using the time-frequency domain mask (S130).

Next, the time-frequency domain signal from which noise has been removed is inversely transformed into a time domain signal (S140).

Next, the speaker and noise mask estimator 130 is trained based on a loss function obtained by comparing the inversely-transformed time domain signal and a pre-defined answer signal (S150).

In the description, each of steps S110 to S150 may be further divided into additional steps or the steps may be combined into smaller steps depending on an implementation example of the present disclosure. Furthermore, some of the steps may be omitted, if necessary, and the sequence of the steps may be changed. Furthermore, although some contents are omitted, the contents described with reference to FIGS. 1 to 7 and the contents described with reference to FIG. 8 may be mutually applied.

The learning method for multi-channel input voice recognition according to an embodiment of the present disclosure may be implemented in the form of a program (or application) in order to be executed by being combined with a computer, that is, hardware, and may be stored in a medium.

The aforementioned program may include a code coded in a computer language, such as C, C++, JAVA, Python, Ruby, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include ROM, RAM, CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

### DESCRIPTION OF REFERENCE NUMERALS

100: device for recognizing multi-channel input voice
110: microphone array selector
120: time-frequency transformer
130: speaker and noise mask estimator
140: beamformer estimator
150: time-frequency inverse transformer
160: learning machine
170: end-to-end voice recognition model

What is claimed is:

1. A device for recognizing a multi-channel input voice independent on a microphone array form, the device comprising:
a time-frequency transformer configured to receive a plurality of channel audio signals extracted from voice data recorded through a plurality of microphones having unspecified microphone array forms and to transform the plurality of channel audio signals into a plurality of time-frequency domain signals;
a speaker and noise mask estimator configured to receive the plurality of time-frequency domain signals and to estimate a time-frequency domain mask for voices and noise for a plurality of speakers;
a beamformer estimator configured to estimate a time-frequency domain signal for voice signals of the plurality of speakers from which the noise has been removed from the plurality of time-frequency domain signals by using the time-frequency domain mask;
a time-frequency inverse transformer configured to inversely transform the time-frequency domain signal from which the noise has been removed into a time domain signal; and
a learning machine configured to train the speaker and noise mask estimator based on a loss function obtained based on results of a comparison between the inversely-transformed time domain signal and a pre-defined answer signal.

2. The device of claim 1, further comprising a microphone array selector configured to select and receive the voice data recorded through a microphone having any one microphone array form, among voice data recorded through microphones having a plurality of microphone array forms, which are mounted on various types of devices.

3. The device of claim 1, wherein the learning machine performs the training by tuning a model parameter that constitutes the speaker and noise mask estimator based on the loss function obtained by calculating a sum of reconstruction loss functions each defined as a distance between the inversely-transformed time domain signal and the answer signal for each speaker.

4. The device of claim 3, wherein the learning machine
obtains the loss functions having a number corresponding to various types of devices having different microphone array forms, and
updates the model parameter with temporary model parameters of the microphone array forms having the number corresponding to the various types of devices through a gradient decent algorithm.

5. The device of claim 4, wherein the learning machine updates a model parameter of the speaker and noise mask estimator with an optimal model parameter derived by performing training in a way to minimize the loss function by applying the gradient decent algorithm to a loss function that is obtained after the temporary model parameter is updated.

6. The device of claim 1, further comprising an end-to-end voice recognition model configured to receive a time-frequency domain signal from which noise has been removed, which is obtained through the time-frequency transformer, the speaker and noise mask estimator, and the beamformer estimator and to output results of voice recognition, based on voice data recorded through a plurality of microphones having specific microphone array forms.

7. The device of claim 6, wherein:
the end-to-end voice recognition model defines a loss function for fine-tuning by comparing the results of the voice recognition and pre-prepared answer information, and
the loss function for the fine-tuning is constructed by adding a connectionist temporal classification loss function and a cross-entropy loss function for each speaker.

8. The device of claim 7, wherein the end-to-end voice recognition model comprises:
a voice recognition encoder configured to receive a time-frequency domain signal of a specific speaker from which noise has been removed and to embed the time-frequency domain signal as a vector that constitutes a hidden vector space; and
a voice recognition decoder configured to receive the vector that constitutes the hidden vector space and to output results of voice recognition of the specific speaker.

9. The device of claim 1, wherein the beamformer estimator receives the time-frequency domain mask and the plurality of time-frequency domain signals, calculates a power spectrum density matrix for the voices and noise for the plurality of speakers, and calculates a filter coefficient of the beamformer estimator based on the power spectrum density matrix, and estimates the time-frequency domain signals for the voice signals of the plurality of speakers from which noise has been removed by applying the filter coefficient to time bin information and frequency bin information in the time-frequency domain signal for the voice and noise of the speaker.

10. The device of claim 9, wherein the beamformer estimator calculates the power spectrum density matrix, based on a mask coefficient for the time bin information and frequency bin information in the time-frequency domain signal for the voice and noise of the speaker and a column vector comprising time-frequency signals of the time bin information and frequency bin information for all of channels.

11. A learning method for multi-channel input voice recognition, the method performed by a device for recognizing a multi-channel input voice independent on a microphone array form comprising:
extracting a plurality of channel audio signals from voice data recorded through a plurality of microphones having unspecified microphone array forms and transforming the plurality of channel audio signals into a plurality of time-frequency domain signals;
estimating a time-frequency domain mask for voices and noise for a plurality of speakers by inputting the plurality of time-frequency domain signals to a speaker and noise mask estimator;
estimating time-frequency domain signals for voice signals of the plurality of speakers from which the noise has been removed from the plurality of time-frequency domain signals by using the time-frequency domain mask;
inversely transforming the time-frequency domain signal from which the noise has been removed into a time domain signal; and
training the speaker and noise mask estimator based on a loss function obtained by comparing the inversely-transformed time domain signal and a pre-defined answer signal.

12. The method of claim 11, wherein the extracting of the plurality of channel audio signals from the voice data recorded through the plurality of microphones having the unspecified microphone array forms and transforming the plurality of channel audio signals into the plurality of time-frequency domain signals comprises:
selecting and receiving the voice data recorded through the plurality of microphones having the unspecified microphone array forms;
extracting a plurality of channel audio signals corresponding to the plurality of microphones from the voice data; and
transforming the plurality of channel audio signals into a plurality of time-frequency domain signals.

13. The method of claim 12, wherein the selecting and receiving of the voice data recorded through the plurality of microphones having the unspecified microphone array forms comprises selecting and receiving voice data recorded through any one microphone having a specific microphone array form, among voice data recorded through microphones having a plurality of microphone array forms, which are mounted on various types of devices.

14. The method of claim 11, wherein the training of the speaker and noise mask estimator comprises:
the learning machine calculates a sum of reconstruction loss functions each defined as a distance between the inversely-transformed time domain signal and the answer signal for each speaker; and
performs learning by tuning a model parameter that constitutes the speaker and noise mask estimator based on the loss function obtained as the sum of the reconstruction loss functions.

15. The method of claim 14, wherein the performing of the learning by tuning the model parameter comprises:
obtaining the loss functions having a number corresponding to various types of devices having different microphone array forms, and
updating the model parameter with temporary model parameters of the microphone array forms having the number corresponding to the various types of devices through a gradient decent algorithm.

16. The method of claim 15, wherein the performing of the learning by tuning the model parameter comprises updating a model parameter of the speaker and noise mask estimator with an optimal model parameter derived by performing training in a way to minimize the loss function by applying the gradient decent algorithm to a loss function that is obtained after the temporary model parameter is updated.

17. The method of claim 11, further comprising:
obtaining a time-frequency domain signal from which noise has been removed based on voice data recorded through a plurality of microphones having specific microphone array forms after the training of the speaker and noise mask estimator is completed; and
outputting results of voice recognition by inputting the time-frequency domain signal from which the noise has been removed to an end-to-end voice recognition model.

18. The method of claim 17, further comprising fine-tuning the end-to-end voice recognition model based on a loss function defined by comparing the results of the voice recognition and pre-pared answer information, wherein the loss function for the fine-tuning is constructed by adding a connectionist temporal classification loss function and a cross-entropy loss function for each speaker.

19. The method of claim 11, wherein the estimating of the time-frequency domain signals for the voice signals of the plurality of speakers from which the noise has been removed comprises:
receiving the time-frequency domain mask and the plurality of time-frequency domain signals and calculating a power spectrum density matrix for the voices and noise for the plurality of speakers;
calculating a filter coefficient of the beamformer estimator based on the power spectrum density matrix; and
estimating the time-frequency domain signals for the voice signals of the plurality of speakers from which noise has been removed by applying the filter coefficient to time bin information and frequency bin information in the time-frequency domain signal for the voice and noise of the speaker.

20. The method of claim 19, wherein the calculating of the power spectrum density matrix comprises calculating the power spectrum density matrix, based on a mask coefficient for the time bin information and frequency bin information in the time-frequency domain signal for the voice and noise of the speaker and a column vector comprising time-frequency signals of the time bin information and frequency bin information for all of channels.
